(19) United States
(12) Patent Application Publication
(10) Pub. No.: US 2008/0314462 A1
(43) Pub. Date: Dec. 25, 2008

(54) Pressure Regulator

(76) Inventors: Yasuaki Nakamura, Shizuoka (JP); Hideto Usui, Shizuoka (JP); Satoshi Komiyama, Shizuoka (JP); Mitsuo Hirotomi, Shizuoka (JP)

Correspondence Address: TROJAN LAW OFFICES, 9250 WILSHIRE BLVD, SUITE 325, BEVERLY HILLS, CA, 90212, US

(21) Appl. No.: 11/575,277

(22) PCT Filed: Sep. 12, 2005
(86) PCT No.: PCT/JP2005/017207

§ 371 Date: Jul. 24, 2008

(30) Foreign Application Priority Data
Sep. 14, 2004 (JP) 2004-266463
Aug. 25, 2005 (JP) 2005-243658

(51) Int. Cl. G05D 16/06

(52) U.S. Cl. 137/614.02; 137/485; 137/614.2

(57) ABSTRACT

A pressure regulator, comprising a pressure regulating mechanism and a connector. A supply connecting tool (3) supplying a pressurized fluid to a body part (11) with the built-in pressure regulating mechanism (5) is connected to the connector (2) to secure excellent pressure regulating function by preventing the pressure regulating function from being affected by the connecting operation of the connecting tool and supply a fluid to stop the reverse flow of fluid caused by the attaching/detaching operations of the connecting tool. The connector (2) comprises a link member (544) openably operating a valve mechanism (6) according to the connecting operation of the supply connecting tool (3). The pressure regulating mechanism (5) comprises a pressure regulating valve (55) operated according to the deviation of a diaphragm (52) to regulate the pressurized fluid to a secondary pressure. The link member (544) is formed separately from the pressure regulating valve (55). Two reverse flow prevention valves (56) and (57) stopping the reverse flow of fluid are installed on the inside and outside of the pressure regulating valve (55).

### TECHNOLOGICAL FIELD

This invention relates to pressure regulators that provide a pressure regulation device for obtaining a fixed secondary pressure and also provide a connector for which the supply connection fixture that supplies pressurized fluid is capable of connection.

### TECHNOLOGICAL BACKGROUND

Normally, with devices used for liquefied gases and gas supply equipment, pressure regulating devices called pressure regulators or governors have come into wide use for pressure reduction of high pressure gas. These pressure regulators are structured to detect the secondary pressure by use of a diaphragm, possess a regulating valve that moves with movement linked to the displacement of the diaphragm, cause operation of the regulating valve so that secondary pressure will remain fixed even at primary pressure fluctuation, and obtain the prescribed secondary pressure.

Regarding such, there can be considered the disposition of a connector for which the supply connection fixture that supplies pressurized fluid is capable of attachment and detachment at time when the pressurized fluid is introduced to the described pressure regulator.

When that connection fixture is connected to the connector, there is caused movement for opening the valve mechanism on the connection fixture side corresponding to the connection movement and for supply of the pressurized fluid, and in conjunction with the connection movement of that occurrence, there is the concern that regulating function will be lost and fluid under pressure higher than the set pressure will be supplied when the diaphragm of the pressure regulating mechanism receives force that displaces it.

In addition, a problem arises in that pressurized fluid remaining within the pressure regulating mechanism may reverse flow, leak, and contaminate the surroundings at time of attachment or detachment of the connection fixture to the connector.

This invention considers the above issues, is a pressure regulator providing a pressure regulating mechanism and a connector, and has as its purpose the provision of a pressure regulator that assures effective pressure regulating function that is not adversely impacted by connection movement of the connection fixture, and additionally, prevents reverse flow of fluid in conjunction with the attachment or detachment of the connection fixture.

### DISCLOSURE OF THE INVENTION

The pressure regulator of this invention is a pressure regulator that provides a main unit with a built-in pressure regulating mechanism and a connector disposed on said main unit to which is connected a supply connection fixture that supplies a pressurized fluid, and is characterized by providing within said connector a linking member for opening a valve mechanism of said supply connection fixture corresponding to the connection movement of said supply connection fixture, by providing a regulating valve that moves corresponding to the displacement of a diaphragm and pressure regulates an introduced pressurized fluid to a prescribed secondary pressure, and is formed with separation of said linking member and said regulating valve.

The pressure regulator of this invention can be made such that said valve mechanism is one that possesses a valve stem for the axis of said valve mechanism in the approximate center, that said linking member is structured with a linking protrusion that extends in the connection movement direction, and that the leading edge of said linking protrusion contacts against said valve stem and causes an opening operation at time of connection of said connector and said supply connection fixture.

At which time, it is preferred that said pressure regulating mechanism be such that it possesses a guidance member of approximately cylindrical shape, that said guidance member possess a barrier wall that protrudes inward at a prescribed position in the connection movement direction, that said barrier wall possess said linking protrusion in the approximate center, and that said linking protrusion possess passage holes on two sides for allowing passage through the barrier wall, and it is additionally preferred that there be fastened, at the barrier wall surface of the side at which said supply connection fixture is connected, a filter for debris removal of cylindrical shape that allows through passage of said linking protrusion and fills said passage holes.

Or it is preferred that said pressure regulating mechanism be such that it possesses a guidance member of approximately cylindrical shape, and that said guidance member possess a barrier wall protruding inward at a prescribed location in the connection movement direction,
that said barrier wall possess in the approximate center an opening to allow through passage of said linking protrusion,
and that there is provided, at the opposite side of the side at which said supply connection fixture is connected, a joint of approximately cylindrical shape for housing a plug possessing said linking protrusion, and it is preferred that said joint provide at the end of the opposite side of the side to which said supply connection fixture is connected a filter for debris removal that crowns said end.

In addition, it is preferred that said guidance member possess a taper on the inner surface enclosing said linking protrusion that becomes larger in aperture diameter at it progresses toward the side of the supply connection fixture.

Furthermore, regarding the pressure regulator of this invention, there can be further provided at the inner side and outer side of said regulating valve of said pressure regulating mechanism two reverse flow check valves for preventing reverse flow of the fluid.

Another pressure regulator of this invention is a pressure regulator that provides a main unit with a built-in pressure regulating mechanism and a connector disposed on said main unit to which is connected a supply connection fixture that supplies a pressurized fluid, and is characterized by said pressure regulating mechanism providing a regulating valve that moves corresponding to the displacement of a diaphragm and pressure regulates an introduced pressurized fluid to a prescribed secondary pressure, and providing, at the inner side and outer side of said regulating valve, two reverse flow check valves for preventing reverse flow of the fluid.

It is preferred that said two reverse flow check valves be structured by disposing at the inner side of said regulating valve a first reverse flow check valve for low pressure operation that performs closing operation in conjunction with displacement of said diaphragm, and disposing at the outer side of said regulating valve a second reverse flow check valve that performs closing operation by receiving pressure emitted from the interior.

It is preferred that said second reverse flow check valve be structured of an elastic plate that blocks the opening of the passage route. It is further preferred that said elastic plate be of a foam body in the interior and possess on the exterior coated an impermeable coating.

The pressure regulator of this invention is one in which the exterior of said diaphragm comprises a first surface on the side of said connector and a second surface on the opposite side, and it is held between a unit case that forms in conjunction with said first surface a pressure regulating chamber for storing said pressurized fluid and a cover case that forms in conjunction with said second surface an atmospheric chamber that passes through to the atmosphere, and said unit case disposes on the diaphragm side surface a cavity for housing said diaphragm.

In addition, it is preferred that said unit case establish at least one passage channel for the passage of said stored pressurized fluid on the surface facing said regulating chamber, and it is further preferred that said regulating chamber be such that it possesses a discharge port for discharging pressurized fluid that has been regulated to said prescribed secondary pressure, and that said passage channel interpose the central axis of the direction of said connection operation and be disposed in a position opposite said discharge port.

According to the pressure regulator of this invention as described above, because there is formation such that the linking member of the connector that opens the valve mechanism corresponding to the connection movement of the supply connection fixture is separated from the regulating valve of the regulating mechanism that moves corresponding to displacement of the diaphragm and regulates the introduced pressurized fluid to a prescribed secondary pressure, there is enabled the maintaining of favorable regulating functions without movement of such as the diaphragm and enabled raising of operational reliability without discharge of fluid having a secondary pressure higher than a set pressure.

In addition, according to the pressure regulator of this invention, because two reverse flow check valves for preventing reverse flow of fluids are provided respectively at the inner side and outer side of the regulating valve of the pressure regulating mechanism, there is enabled the quick and reliable prevention of leakage due to reverse flow of fluid when the pressure of the pressure regulating mechanism interior is either of a low pressure or a high pressure.

### BRIEF DESCRIPTION OF THE DRAWINGS

FIG. 1 is a full unit cross section drawing showing the separated condition of the connector of the pressure regulator according to the first embodiment of this invention.

FIG. 2 is a main component expanded cross section drawing of the connector structure of FIG. 1.

FIG. 3 is a perspective drawing of the pressurized container that has provided the supply connection fixture.

FIG. 4 is an exploded view perspective drawing of the main components of the fastening mechanism.

FIG. 5 is a cross section drawing showing the maximum pressed inward condition at connection movement of the supply connection fixture.

FIG. 6 is a cross section drawing showing the locked condition of the connected supply connection fixture and connector.

FIG. 7 is cross section perspective drawing showing the relationship between the supply connection fixture and operating member for the lock released condition.

FIG. 8 is a cross section perspective drawing identical to that of FIG. 7 but showing the locked condition.

FIG. 9 is an exploded view perspective drawing of the pressure regulating mechanism.

FIG. 10 is a main component cross section drawing showing another embodiment of the second reverse flow check valve.

FIG. 11 is a main component cross section drawing showing the pressurized fluid introduction condition regarding the example of FIG. 10.

FIG. 12 is a partial cross section perspective drawing showing the pressure regulator according to the second embodiment of this invention with a cutaway of an approximately 90 degree region along the circumference of the periphery of the central axis and a partial expanded view.

FIG. 13 is a component expanded view cross section drawing showing an enlargement of the upper section of the pressure regulating mechanism of FIG. 12.

FIG. 14 is a partial cross section expanded perspective drawing showing the assembled lower section of the pressure regulating mechanism of FIG. 12 with a cutaway of an approximately 90 degree region along the circumference of the periphery of the central axis and a partial expanded view.

FIG. 15 is a cross section drawing showing the maximum pressed inward condition at connection movement of the supply connection fixture.

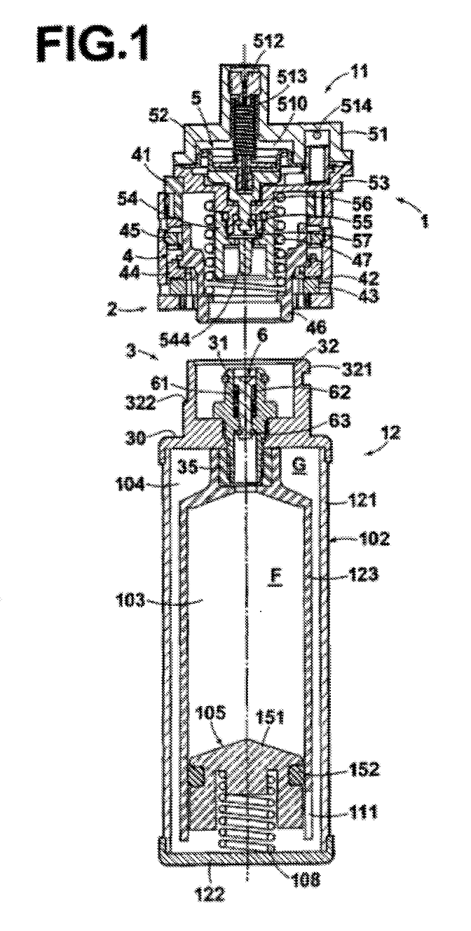

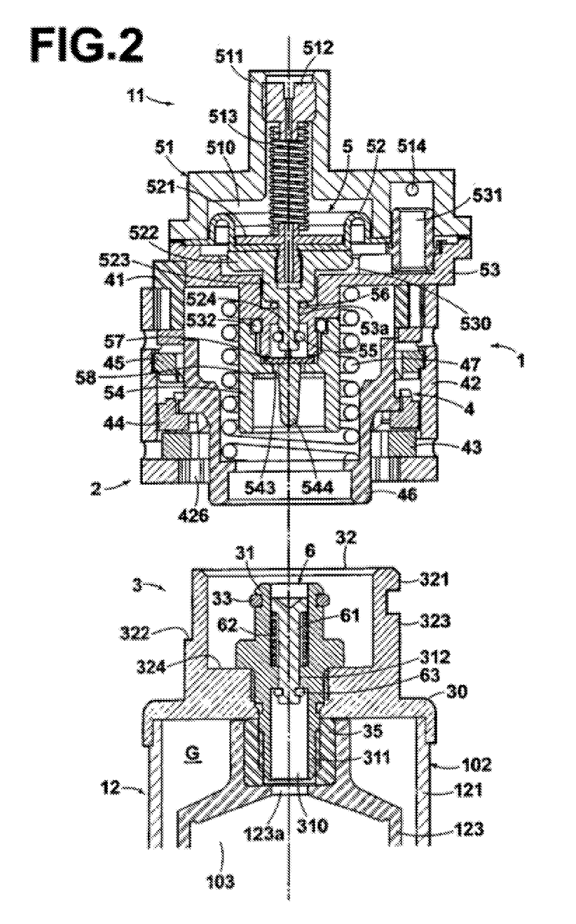

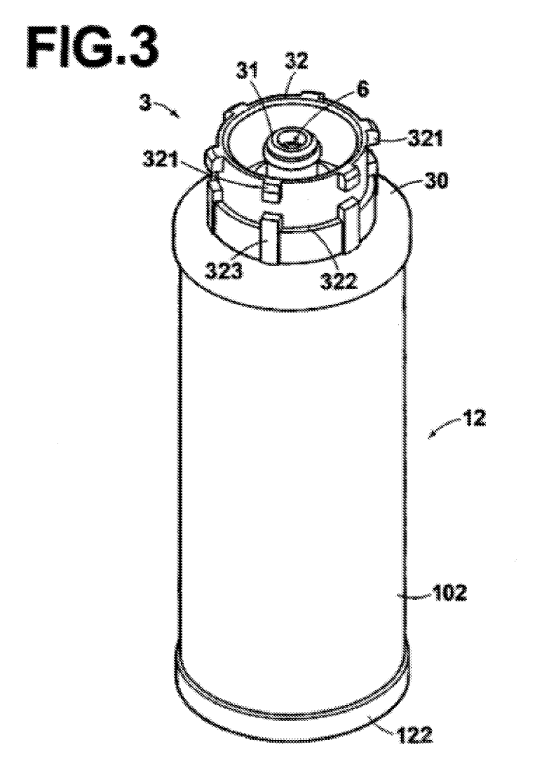

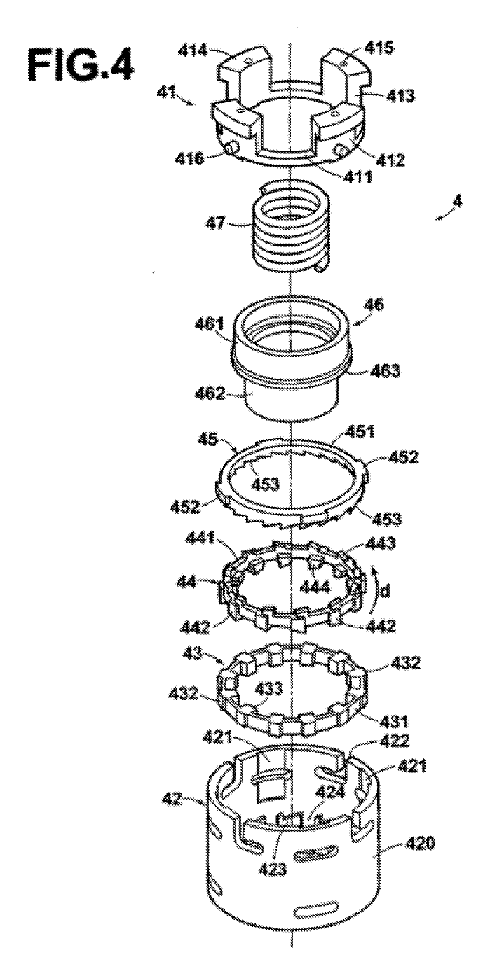

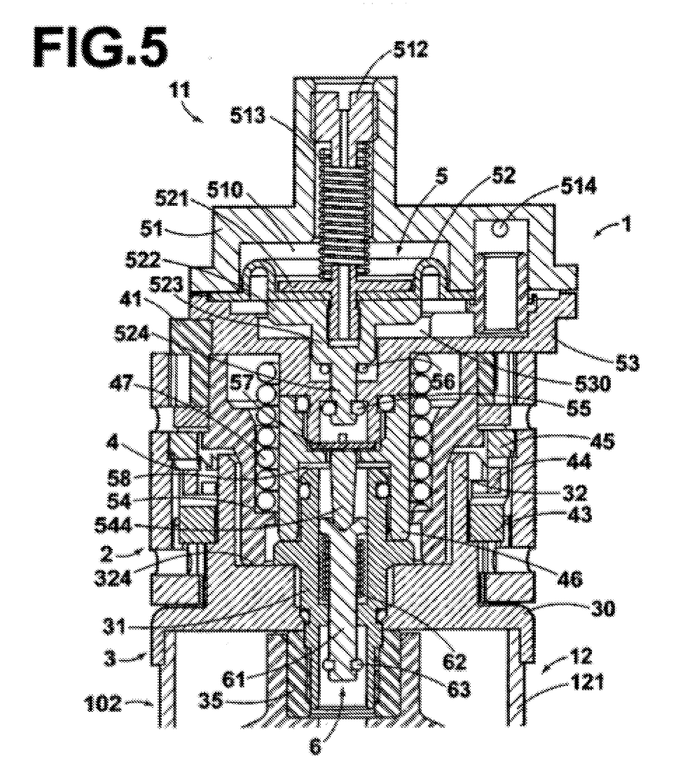

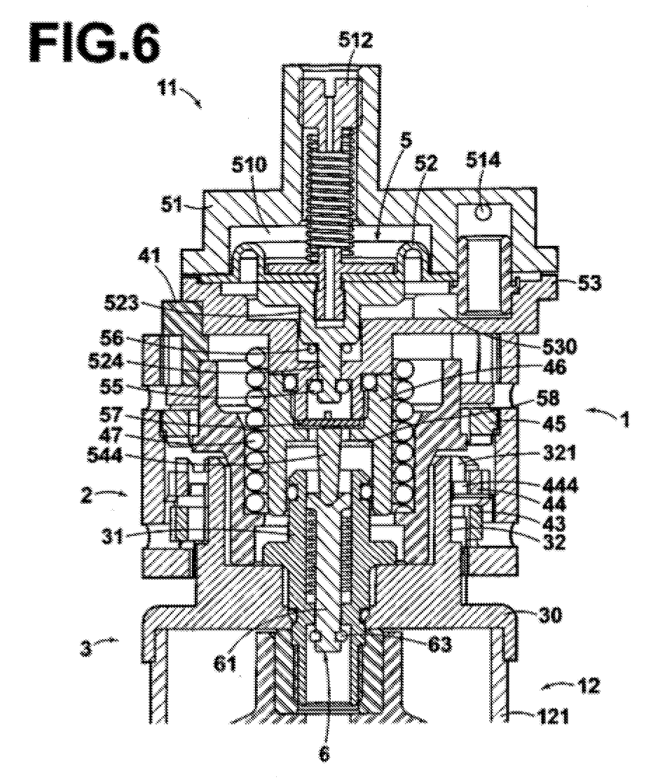

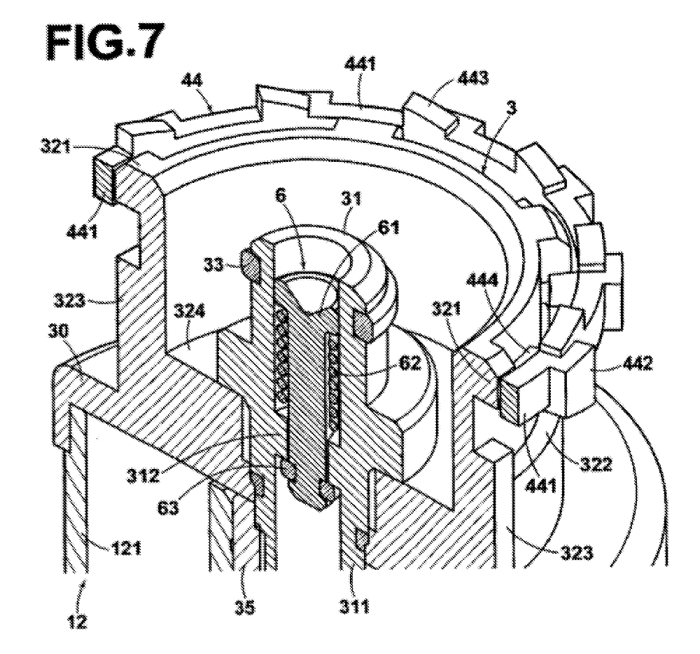

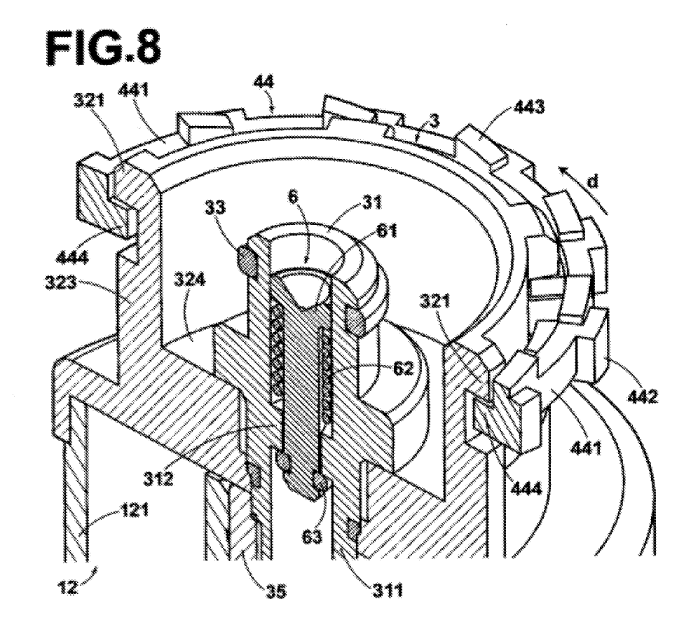

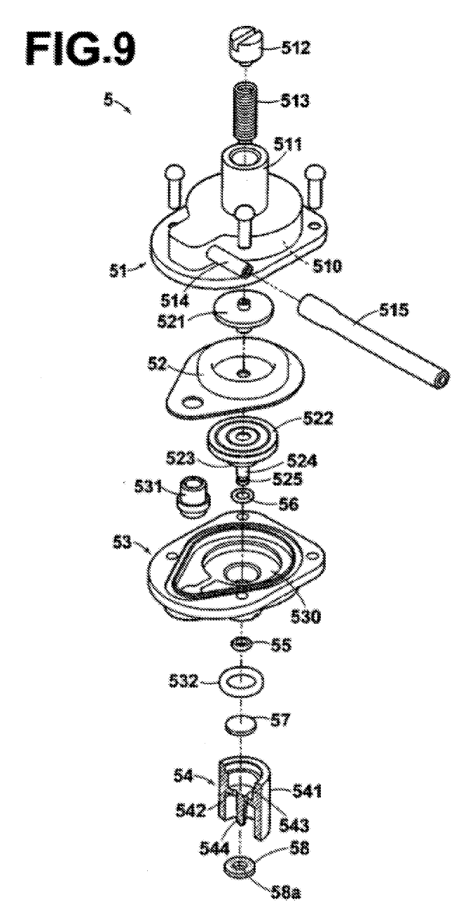

The following section describes in detail embodiments of this invention. FIG. 1 is a full unit cross section drawing showing the separated condition of the connector of the pressure regulator according to the first embodiment; FIG. 2 is a main component expanded cross section drawing of FIG. 1; FIG. 3 is a perspective drawing of a pressurized container providing the reception connector; FIG. 4 is an exploded view perspective drawing of the main components of the fastening mechanism of the connector; FIG. 5 is a cross section drawing showing the maximum pressed inward condition at connection movement of the connector; FIG. 6 is a cross section drawing showing the locked condition; FIG. 7 is cross section perspective drawing showing the lock released condition; FIG. 8 is a cross section perspective drawing identical to that of FIG. 7 but showing shift to the locked condition; and, FIG. 9 is an exploded view perspective drawing of the pressure regulating mechanism. Furthermore, the descriptions that follow are given with reference to the drawings in top-to-bottom and left-to-right orientation, but actual disposition direction may be in horizontal orientation in which the centerline follows a level plane direction rather than the vertical orientation in which the centerline extends in a perpendicular direction (or inversion of top-to-bottom) as shown in FIG. 1.

Pressure regulator 1 of the embodiment of FIGS. 1 and 2 possesses main unit 11 that provides pressure regulating mechanism 5 (governor mechanism) for regulating the supply pressurized fluid to a fixed secondary pressure, and to a connector 2 disposed on this main unit 11 there is connected supply connection fixture 3 disposed on pressurized container 12 of such as a fuel cartridge for supplying a fluid in a pressurized condition.

Above described main unit 11 is disposed on such as a fuel cell that uses a fluid such as liquid fuel, and at supply of fluid F to main unit 11 from pressurized container 12, it is such that it connects with supply connection fixture 3 in a lock condition by functioning of fastening mechanism 4 (ratchet mechanism) of connector 2. Supply connection fixture 3 provides at plug-shaped supply connection port 31 valve mechanism 6 on which force is applied in the closing direction by functioning of spring 62.

The structure is such that the leading portion of supply connection fixture 3 is connected by insertion to the interior of connector 2, an opening operation is executed by insertion shifting of valve stem 61 of supply connection fixture 3, pressure regulating mechanism 5 of main unit 11 operates corresponding to supply of the pressurized fluid, and the fluid pressure regulated to a fixed secondary pressure is supplied from pressure regulator 1. In addition, these are disposed in a structure such that at the above described connection operation, in conjunction with the pressing inward operation for connection of supply connection fixture 3, second ring 44 in fastening mechanism 4 shifts and mates to a portion of supply connection fixture 3 and maintains connector 2 in a locked condition, and at time of separation, in conjunction with the next pressing inward operation of supply connection fixture 3, second ring 44 further shifts and modifies the locked condition to a released condition, and connector 2 and supply connection fixture 3 are forcibly modified to a separated condition by release spring 47.

Next, the following section describes specifically the structure of each component. First, as shown in the cross section drawing of FIG. 2 and the exploded view perspective drawing of FIG. 9, pressure regulating mechanism 5 in main unit 11 of pressure regulator 1 provides diaphragm 52 held between cover case 51 and unit case 53, guide member 54 that is connected to unit case 53 and by which is guided the fluid (liquid or gas) of primary pressure, and with linked movement to diaphragm 52, regulating valve 55 that reduces the primary pressure to the secondary pressure, first reverse flow check valve 56 (low pressure check valve) and second reverse flow check valve 57 (high pressure check valve) that prevent leakage of fluid, and filter 58 for dust removal.

Above described first reverse flow check valve 56 also functions as a regulating valve. Regulating valve 55 and first reverse flow check valve 56 perform linked movement in correspondence to displacement of diaphragm 52, are components regulating primary pressure to secondary pressure by reciprocally opposing closing movement, and the regulating properties for primary pressure change become opposite properties with each of regulating valve 55 and first reverse flow check valve 56. In this way, at diaphragm 52 the pressure loss operated by primary pressure on the reflection surface of regulating valve 55 and the pressure loss operated by secondary pressure on the reflection surface of first reverse flow check valve 56 are added in the same direction, and by the combination of both regulating properties regulating error within the secondary pressure is compensated by the pressure loss fluctuation corresponding to primary pressure fluctuation, and this obtains a fixed secondary pressure. Furthermore, regulating valve 55 and first reverse flow check valve 56 perform opening and closing operations in opposition to the displacement of diaphragm 52, and they are intended to simplify manufacturing by canceling out regulating fluctuations due to installation position error of either member and by relieving production precision.

Fastening mechanism 4 of connector 2 is disposed on the periphery of guide member 54 of pressure regulating mechanism 5, and, as shown in FIG. 2, this fastening mechanism 4 provides holder unit 41 and ratchet holder 42 affixed to described unit case 53, first ring 43, second ring 44 and third ring 45 disposed within ratchet holder 42, spring holder 46 that slides freely in the axial direction, and release spring 47.

Second ring 44 rotates by one increment corresponding to the connection movement of described supply connection fixture 3 and performs mating lock for supply connection fixture 3, and by the next pressing inward movement of supply connection fixture 3, second ring 44 further rotates by one increment and releases mating lock, and supply connection fixture 3 is forcibly separated by the application force of release spring 47. The one increment forwarding described above is performed such that force is operated in the rotation direction by pressing pressure on the inclined surfaces between the rings.

Supply connection fixture 3 disposed at the top of pressurized container 12 provides supply connection port 31 with built-in valve mechanism 6 at the center of connector unit 30, and it possesses connection cylinder 32 at the periphery of supply connection port 31 and protruding outward in the axial direction. As shown in FIG. 3, there are provided mating protrusions 321 used for locking that protrude at equal intervals from the leading edge periphery of connection cylinder 32, and they are capable of mating with lock protrusions 444 of second ring 44. Furthermore, the cross section position for connection cylinder 32 differs in FIGS. 1 and 2.

At a prescribed position from the leading edge of connection cylinder 32, pressing shoulder 322 protrudes in an annular shape to the outer side, and as described hereafter, it contacts against inner protrusions 433 of first ring 43 and causes shifting in the axial direction corresponding to connection movement. In addition, spline-shaped protrusions 323 protrude from pressing shoulder 322 toward mating protrusions 321, and along with the formation of an annular space between these and mating protrusions 321 for rotational movement of second ring 44, these prevent other rotation by mating with vertical channels 426 at the lower periphery of ratchet holder 42 of connector 2.

Supply connection port 31 is formed in a pipe shape, seal member 33 of an O-ring is installed at the leading edge periphery, nut 35 is installed and tightened on lower end 311 passed through connector unit 30, and valve stem 61 of valve mechanism 6 is disposed to slide freely at the inner periphery of intermediate step 312. Lower end 311 and connector unit 30 are sealed by O-ring 315 disposed within the peripheral channel of lower end 311. Valve body 63 of an O-ring is installed at the lower end of valve stem 61 and protrudes beyond intermediate step 312. The indentation in the top of valve stem 61 is able to contact against the leading edge of linking protrusion 544 of guide member 54, and spring 62 (return spring) is installed with compression between the underside of the top section and intermediate step 312 and applies force in the valve closed direction.

Next, the following section describes the structure of fastening mechanism 4 in connector 2 by reference to FIGS. 2 and 4. Ratchet holder 42 shown at the lower side of FIG. 4 is formed in an annular shape, and it is fixed to holder unit 41 shown at the upper side of the same drawing by the upper edge of cylinder 420. At the inner surface of cylinder 420 of ratchet holder 42 there are provided four peripheral direction first guide channels 421 positioned at an approximately intermediate position from the opposite end of an extension in the axial direction, L-shaped mating channels 422 passing from interior to exterior from the upper edge surface and positioned between first guide channels 421, ratchet protrusions 423 disposed in multiple quantity (12 protrusions) at equal intervals of the inner periphery at the lower side, and second guide channels 424 in multiple quantity (12 channels) at equal intervals of the inner peripheral surface between ratchet protrusions 423 and extending in the axial direction, and there are at the upper end of ratchet protrusions 423 inclined surfaces and stop steps, and the upper surfaces of stop steps are inclined identically to inclined surfaces and also face second guide channels 424.

First ring 43 (slide ring) provides guide protrusions 432 of multiple quantity (12 protrusions) at equal intervals on the outer periphery of ring base 431 and provides inner protrusions 433 on the inner periphery at positions matching guide protrusions 432. Guide protrusions 432 of the periphery are at ordinary time inserted within second guide channels 424 of ratchet holder 42, and this first ring 43 does not rotate but shifts only upward or downward. At the lower surfaces of inner protrusions 433, the upper edge of pressing shoulder 322 of connection cylinder 32 of supply connection fixture 3 is able to make contact when raised, and that pressing pressure raises first ring 43 in the axial direction. Furthermore, mating protrusions 321 of connection cylinder 32 are capable of insertion passage through the vertical channels between the inner protrusions 433.

Second ring 44 (lock ring) provides guide protrusions 442 of multiple quantity (12 protrusions) at equal intervals on the outer periphery of ring base 441, slide hooks 443 with inclined surfaces of multiple quantity (12 hooks) at equal intervals on the upper surface, and lock protrusions 444 of multiple quantity (12 protrusions) projecting at equal intervals from the inner periphery, and it executes rotation movement in rotation direction d. Guide protrusions 442 of the outer periphery and lock protrusions 444 of the inner periphery are identically positioned in the peripheral direction, and both are linked at the bottom section of ring base 441, and these bottom common sections are established with the sides facing the forward direction of rotation direction d higher and the sides facing the backward direction lower. In addition, the upper surfaces of slide hooks 443 projecting from the upper surface are established with sides facing the forward direction of rotation direction d higher and the sides facing the backward direction lower.

Guide protrusions 442 of the outer periphery are inserted into second guide channels 424 of ratchet holder 42 and they guide the sliding movement of second ring 44 in the axial direction, and at large upward movement of second ring 44, guide protrusions 442 exit second guide channels 424 and second ring 44 becomes capable of rotation. Due to rotation, when the lower edge inclined surfaces of guide protrusions 442 descend in a condition capable of contacting inclined surfaces or the upper edge inclined surfaces of stop steps of ratchet protrusions 423, there is further rotation by contact of these companion inclined surfaces, and therefore either the leading edges of guide protrusions 442 enter a locked condition by having mated with stop steps or guide protrusions 442 enter a separated condition by having inserted into second guide channels 424, and rotation stops. In addition, by the rotation movement in conjunction with the connection movement, lock protrusions 444 of the inner periphery shift to the inner side of mating protrusions 321 used for locking by connection cylinder 32 of supply connection fixture 3 and are capable of the mating lock condition.

Third ring 45 (guide ring) provides four guide protrusions 452 at equal intervals of the outer periphery of ring base 451 and hooking teeth 453 having inclined surfaces of ratchet hook shape on the lower surfaces. Guide protrusions 452 are inserted into first guide channels 421 of ratchet holder 42, and third ring 45 is capable of upward and downward shifting in the axial direction (rotation not possible), and the bottom end position is limited by guide protrusions 452 mating against the lower edge of first guide channels 421 so that it separates from from second ring 44. Hooking teeth 453 at the lower surface contact slide hooks 443 on the upper surface of second ring 44 and cause rotation of second ring 44 by the contact of the companion inclined surfaces.

Spring holder 46 comprises annular-shaped upper cylinder 461 and comparatively smaller diameter lower cylinder 462, and release spring 47 is installed with compression within, and outer periphery shoulder 463 at the lower end of upper cylinder 461 contacts and applies force from the upper direction onto lock protrusions 444 of second ring 44. In this way, floating movement is prevented when second ring 44 separates from third ring 45.

In addition, lower cylinder 462 of spring holder 46 is inserted within first through third rings 43˜45 and extends downward within ratchet holder 42, and it possesses an opening in the bottom center that receives release spring 47, and supply connection port 31 of supply connection fixture 3 is inserted within the opening. Furthermore, the lower end of lower cylinder 462 is capable of contacting interior surface 324 of connector unit 30 of supply connection fixture 3, and this enables upward shifting movement by the resistance of spring holder 46 against release spring 47 by the connection movement of supply connection fixture 3.

Release spring 47 is a coil spring installed with compression between the lower surface flanges of unit case 53 of connector 2, and it passes through spring holder 46 and presses against third ring 45 and applies force on supply connection fixture 3 disconnection and separation direction.

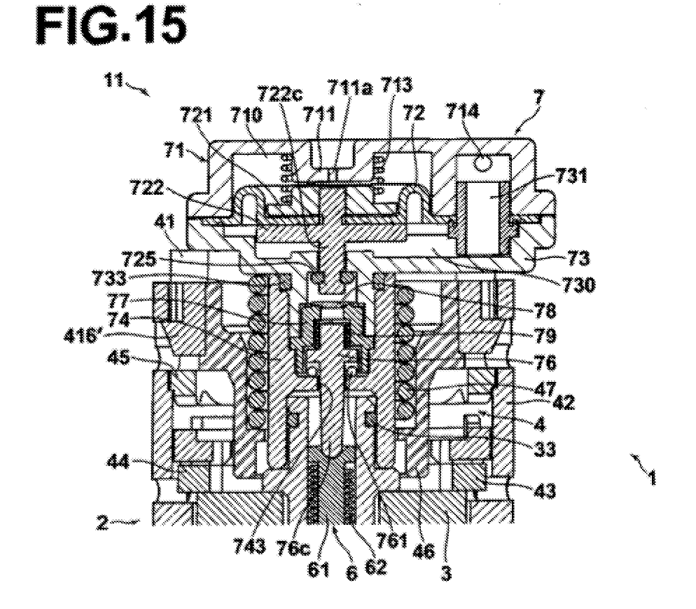

Holder unit 41 is fixed to diaphragm 52 and fastened to unit case 53 of connector 2. Ring section 411 at the bottom end consolidates the unit, there are provided four fixed sections 412 extending upward at equal intervals and vertical channels 413 between fixed sections 412, screw holes 415 are formed in flanges 414 protruding outward at the upper edge of fixed sections 412, and four pin protrusions 416 protrude outward one each from the outer surface of each of fixed sections 412 below flanges 414. Pin protrusions 416 are capable of mating with L-shaped mating channels 422 of ratchet holder 42, thereby enabling assembly. Furthermore, the structure used in this embodiment as described above includes mating between holder unit 41 and ratchet holder 42, but this invention is not limited to such, and, for example, it is acceptable to use a method for mating in which release of fastening hooks are not capable of detachment from elliptical holes by disposing at the peripheral surface of holder unit 41 fastening hooks 416′ (reference FIG. 15) that mate with approximately elliptical holes disposed in the approximate center of the vertical direction within first guide channels 421 of ratchet holder 42 and pressing holder unit 41 into ratchet holder 42 without allowing rotation.

The following section describes specifically the structure of pressure regulating mechanism 5. By joining unit case 53 and cover case 51 around diaphragm 52, there is formed regulation chamber 530 and atmospheric chamber 510 within the interior space. Diaphragm 52 is capable of elastic displacement corresponding to the pressure difference between atmospheric chamber 510 and the received secondary pressure of regulation chamber 530, and in the center area, supporter 521 is fastened to atmospheric chamber 510 and on the other side shaft 522 is fastened to regulation chamber 530, and they are capable of integrally shifting in the axial direction corresponding to displacement of diaphragm 52.

Shaft 522 provides boss 523 fastened to diaphragm 52 and positioned in regulation chamber 530 and provides shank 524 extending in the axial direction from the leading edge of boss 523, and it possesses peripheral channel 525 at the leading edge of shank 524, and regulating valve 55 of an O-ring is installed in this peripheral channel 525, and furthermore, first reverse flow check valve 56 of an O-ring (elastic body) is installed at the leading edge surface of boss 523 as a base component of shank 524.

The bolt section in the center of the supporter 521 flange firmly fastened to diaphragm 52 passes through the center of diaphragm 52 and is tightened securely to shaft 522 on the opposite side. In addition, one end of regulator spring 513 disposed within cylinder section 511 of cover case 51 and used for pressure setting contacts supporter 521, and the other end of regulator spring 513 contacts regulator screw 512 (adjustor) which is screwed into cylinder section 511 and capable of position adjustment, and corresponding to adjustment of the axial direction position of regulator screw 512, there is adjustment of the application force of diaphragm 52 by regulator spring 513. It is preferred that regulator screw 512 be of polyoxymethylene (POM) and regulator spring 513 be of stainless steel.

Guide member 54 of the lower section provides cylinder section 541 at the periphery, barrier wall 542 at the median, linking protrusion 544 that protrudes downward from barrier wall 542 and acts as a linking member for executing linking operation of valve stem 61, and passage holes 543 that pass through barrier wall 542 on either side of linking protrusion 544.

On the upper surface of barrier wall 542 of guide member 54 and with capability to block the opening of passage hole 543 is disposed second reverse flow check valve 57 of such as a rubber plate or sandwich plate for high pressure blocking. When supply connection fixture 3 has been separated with the secondary pressure of regulation chamber 530 in a relatively high condition, that secondary pressure causes second reverse flow check valve 57 to function as a reverse check valve to block passage hole 543, and this prevents fluid from leaking to the outside.

The upper end of cylinder section 541 of guide member 54 passes around O-ring 532 and is joined with removable capability to the periphery of the leading edge cylinder section of unit case 53, and the opposite end of cylinder section 541 mates to seal member 33 at the forward end periphery of supply connection port 31 of supply connection fixture 3 and guides the pressurized fluid.

Unit case 53 provides partition wall 53a within the leading edge cylinder section, inserted with capability to allow slide movement for shank 524 of shaft 522, and the interior and exterior of partition wall 53a is opened and closed by regulating valve 55 and first reverse flow check valve 56. Opposing open and close movements are executed by regulating valve 55 opening in conjunction with forward shifting of shank 524 and by first reverse flow check valve 56 opening in conjunction with rearward shifting. In addition, when supply connection fixture 3 has been separated with the pressure of regulation chamber 530 in a low condition, first reverse flow check valve 56 functions as a check valve to block the reverse flow of fluid by closing due to secondary pressure.

Discharge port 514 for discharging regulated secondary pressure gas through cylinder section 531 is disposed within the interior of regulation chamber 530, and pipe 515 that leads regulated fluid to the fuel cell is connected to discharge port 514.

When supply connection fixture 3 is connected to connector 2, the leading edge of previously described linking protrusion 544 of presses against valve stem 61 and causes the opening operation. Linking protrusion 544 is fastened to barrier wall 542 of guide member 54 and is of a structure separated from shank 524 executing linked movement with diaphragm 52, and at connection movement it does not receive force from the displacement of diaphragm 52.

Rephrased, the leading edge of shank 524 is capable of causing a linking operation with valve stem 61, and in that event, when pressing inward force is maintained so the maximum pressing inward condition is continued, that action causes loss of regulating function by diaphragm 52 displacement, and there is concern that fluid under pressure higher than the set secondary pressure will be supplied, but by separating linking protrusion 544 from diaphragm 52, it is possible to maintain the regulating function and prevent supply of fluid under pressure higher than the set secondary pressure.

At the lower surface of barrier wall 542 of guide member 54, filter 58 is interposed to remove foreign objects such as dust from within the supplied fluid. Filter 58 is of a circular plate shape possessing hole 58a, and its outside diameter is formed to be slightly larger than the outside diameter of barrier wall 542, and additionally, its inside diameter to be slightly smaller that the base diameter of linking protrusion 544, and by insertion installation from beneath guide member 54 it is firmly installed to prevent falling.

The material of this filter 58 is a low density polyethylene (LDPE) foam body of 85% void, cell average diameter 30 micrometers and thickness 1 mm, for example. By firmly installing filter 58 within the fluid route, there is prevented the mixing of minute debris existing in the supply fluid, and along with preventing the generation of poor results in the reverse flow prevention operation of such as the regulating operation of regulating valve 55 and first reverse flow check valve 56 for primary pressure regulation and second reverse flow check valve 57, it prevents the generation of poor movement of the operational members of main unit 11. The material of the foam body should be selected from at least one of polyethylene, polypropylene, polyoxymethylene, polyethylene terephthalate, polyethylene naphthalate or from the group comprising polyacrylonitrile.

Next, the following section describes the structure of pressurized container 12. Pressurized container 12 comprises container unit 102 disposed at the head of connector unit 30 of supply connection fixture 3, storage chamber 103 storing fluid F and formed in the interior of container unit 102, gas chamber 104 enclosing pressurized gas G by which is generated reactive force for pressing out fluid F and formed in the interior of container unit 102 and reciprocally links with storage chamber 103 at the end, barrier wall 105 of piston shape for dividing fluid F from gas G and disposed to slide freely in storage chamber 103, and elastic body 108 compressed at the bottom section of container unit 102 when barrier wall 105 has descended.

Container unit 102 is structured of outer container 121, cover 122 sealing closed the bottom, and inner container 123 disposed with a double construction in the interior of outer container 121. At the lower end of inner container 123, notch 111 is formed extending in a vertical direction, and it enables passage between the interior of inner container 123 and the interior of outer container 121, which is storage chamber 103 and gas chamber 104. The upper end of inner container 123 is installed with mating to nut 35 fastened to lower end 311 of supply connection port 31, and inner container 123 is maintained in this condition. In the center of the upper end of inner container 123 there is opened passage hole 123a, and corresponding to the opening and closing movements of valve stem 61 of valve mechanism 6, discharge supply of fluid F within storage chamber 103 is performed.

In addition, barrier wall 105 is inserted with close fitting and capable of sliding, it is structured of main section 151 and elastic seal member 152 (O-ring), and the periphery of seal material 152 contacts the cylindrically shaped inner wall of inner container 123 with air tightness, and fluid F is enclosed in storage chamber 103 in the space above it. Barrier wall 105 functions as a sliding barrier that divides the pressurized gas stored in gas chamber 104 from the fluid F stored in storage chamber 103, and by the pressure of the compressed gas operating on the rear surface it applies pressure to fluid F at the forward surface, and at opening operation by valve stem 61, it operates to discharge fluid F.

The enclosure of pressurized gas G within gas chamber 104 is performed with supply connection fixture 3 in a separated condition and prior to injection of fluid F to storage chamber 103. First, compressed gas G passes valve stem 61 that has undergone opening operation by a pressing inward operation, and corresponding to its entry to storage chamber 103, barrier wall 105 descends, and by further injection of the compressed gas to storage chamber 103, barrier wall 105 further shifts from the position shown by FIG. 1 to the bottom of storage chamber 103 by compressing elastic body 108. In maximum descent condition, the upper portion of notch 111 rises above seal material 152 of barrier wall 105, and the pressurized gas is injected to gas chamber 104 from storage chamber 103 by passing through notch 111. After stoppage of compressed gas injection at time gas chamber 104 reaches a prescribed pressure, valve stem 6 undergoes opening operation again and compressed gas within storage chamber 103 is expelled. In response, barrier wall 105 returns to a seal condition within storage chamber 103, and by further expulsion of gas it ascends to the upper end of inner container 123, and by expelling all gas within storage chamber 103, compressed gas G is enclosed within gas chamber 104. After this, by connecting a filling means to supply connection fixture 3 and injecting fluid F past valve stem 61 and into storage chamber 103, thereby causing barrier wall 105 to descend, it is possible to obtain pressurized container 12 storing fluid F capable of discharge.

Moreover, it is also acceptable to store a compressed gas as a fluid within pressurized container 12, and in such an instance the gas is stored directly n the outer container without utilizing the inner container. Additionally, it is acceptable to obtain internal pressure (primary pressure) for discharging supply fluid by using a so-called aerosol structure with dispersal material mixed with the fluid.

Basically, with the connection operation of described supply connection fixture 3 with connector 2, there can be performed insertion of supply connection port 31 of supply connection fixture 3 into guide member 54 of connector 2 and obtaining of a sealed condition by contact of seal member 33, enabling of supply by causing linkage of the passage for fluid by opening operation of valve mechanism 6 of supply connection fixture 3, and locking by fastening mechanism 4.

The order of operation at time of connection (installation) is that seal member 33 first contacts the inner surface of cylinder section 541 of guide member 54, and after sealing is assured, valve stem 61 of valve mechanism 6 is opened by the leading edge of linking protrusion 544, following which second ring 44 of fastening mechanism 4 rotates and enters the locked condition. Conversely, the order at time of release (disconnection) is that second ring 44 of fastening mechanism 4 rotates and the locked condition is released, following which valve stem 61 closes and blocks the passage, and lastly seal member 33 is separated from guide member 54 and released.

Next, the following section describes the connection of supply connection fixture 3 to connector 2 and the movement primarily of fastening mechanism 4 by referencing FIGS. 5˜8.

In the separated condition prior to connection, as shown in FIG. 2, outer periphery shoulder 463 of spring holder 46 of fastening mechanism 4 contacts and applies pressure on lock protrusions 444 of second ring 44, guide protrusions 432 of first ring 43 and guide protrusions 442 of ratchet holder 42 are located within second guide channels 424 of ratchet holder 42, second ring 44 is incapable of rotation, and third ring 45 is in a position at which the descent position is restricted. In this condition, first reverse flow check valve 56 of pressure regulating mechanism 5 closes, and valve stem 61 of supply connection fixture 3 is also in the closed condition.

In response to pressing inward movement of supply connection fixture 3, the initial stage is one in which mating protrusions 321 used for locking of connection cylinder 32 shift and pass through the vertical channels of first ring 43 and second ring 44, the lower end of spring holder 46 contacts interior surface 324 of supply connection fixture 3 and continues to press upward, and pressing shoulder 322 contacts and presses upward against the lower surface of first ring 43. In conjunction with this, second ring 44 also ascends, and it contacts the lower surface of third ring 45 stopping at the lower end of first guide channels 421. During transit, guide protrusions 442 of second ring 44 depart from the upper end of second guide channels 424 of ratchet holder 42 and become capable of rotation, and by contact with the inclined surfaces of hooking teeth 453 on the bottom surface of third ring 45, second ring 44 receives force in rotation direction d.

FIG. 5 shows the maximum pressed inward condition of supply connection fixture 3, and in this condition the upward movement of third ring 45 is restricted, second ring 44 is rotated in rotation direction d above first ring 43 by inclined surface contact with third ring 45, and as shown in FIG. 8, at rotation of second ring 44, lock protrusions 444 shifts and mates with the inner side of mating protrusions 321 for locking of connection cylinder 32 of supply connection fixture 3 and locks with inability to shift for detachment. In the condition of FIG. 5, linking protrusion 544 causes valve stem 61 to undergo an opening operation and commence supply of fluid.

Subsequently, from the maximum pressed inward condition, at release of the pressing inward movement, supply connection fixture 3 is applied with force for retreat by the application force of release spring 47, while mating protrusions 321 for locking of connection cylinder 32 of supply connection fixture 3 mate with lock protrusions 444 of second ring 44 and shift downward, and third ring 45 and first ring 43 integrally shift downward. Then, when third ring 45 descends and stops at the lower ends of first guide channels 421, previously separated second ring 44 further descends, thereby causing the contact of the inclines of both sides to become separated, and by the above described second ring 44 rotation, the leading edges of guide protrusions 442 of the lower edge shift from the position of second guide channels 424 to one above inclined the surfaces of ratchet protrusions 423, contact these inclined surfaces, and by further descent of second ring 44 additionally rotate along the inclines.

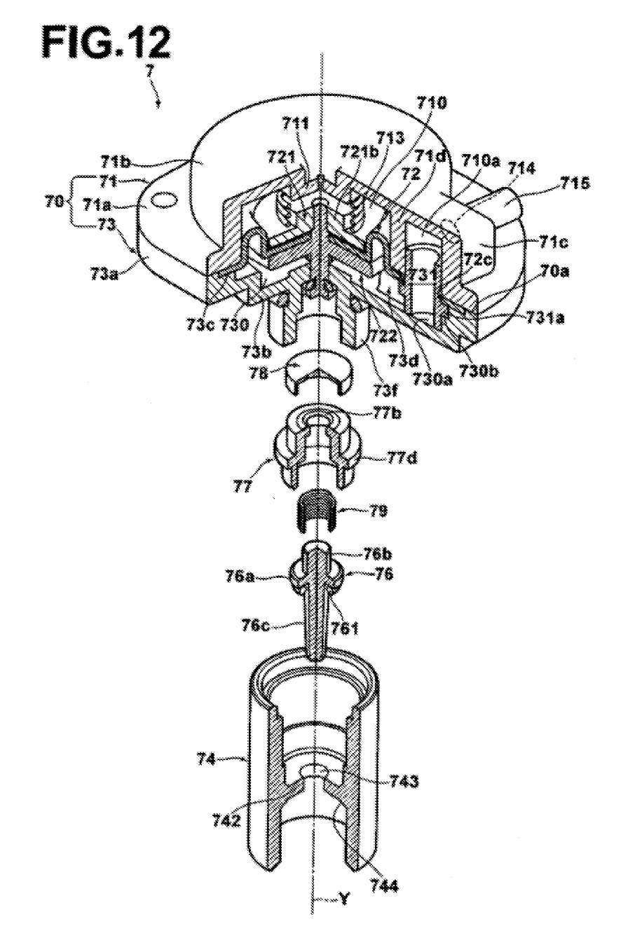

Then, as shown in FIG. 12, guide protrusions 442 of second ring 44 contact against stop steps 423b and stop rotation, and descent beyond that point is stopped, and supply connection fixture 3 mating with lock protrusions 444 of second ring 44 is locked, resulting in the locked condition being connected and unable to separate.

FIG. 6 is a cross section drawing of the locked condition, with pressure regulating mechanism 5 operating and fluid regulated to the prescribed pressure being supplied to main unit 11 from discharge port 514.

Subsequently, at release movement from the described locked condition, when supply connection fixture 3 again undergoes a pressing inward movement, first ring 43 and second ring 44 move upward, the lower end of second ring 44 is separated from stop steps and becomes capable of rotation, second ring 44 rotates by contact with the inclined surfaces of hooking teeth 453 of third ring 45, and in conjunction with the subsequent retreat movement of supply connection fixture 3, the inclined surfaces of guide protrusions 442 of second ring 44 reach second guide channels 424 from stop steps and contact the inclined surfaces, and by this inclined surface contact second ring 44 is further rotated in rotation direction d, and guide protrusions 442 rotate to a position at which they will inserted into second guide channels 424. As shown in FIG. 7, at this rotation position of second ring 44, mating protrusions 321 become detached from lock protrusions 444 and align with the positions of the vertical channels, mating lock is released, connection cylinder 32 of supply connection fixture 3 becomes capable of separation and shifting, and by the application force of release spring 47 it passes through spring holder 46 being applied with a separation operation and is ejected.

Described pressure regulating mechanism 5 is a component that executes attenuation adjustment of the primary pressure to a prescribed secondary pressure not having a relationship to the primary pressure, and it does so by the pressure adjustment of regulating valve 55 and first reverse flow check valve 56 in conjunction with the movement of diaphragm 52.

FIG. 6 shown the pressure adjustment condition, with the fluid regulated by regulating valve 55 and first reverse flow check valve 56 flowing into regulation chamber 530 and being discharged port 514 following precise pressure reduction to the secondary pressure.

Diaphragm 52 maintains a position at which the application force from regulator spring 513 has been equalized with the application force from the pressure difference between the secondary pressure and atmospheric pressure. Therefore, when the secondary pressure changes corresponding to such as fluctuation of the fluid discharge amount from discharge port 514 or fluctuation of the primary pressure, the displacement amount of diaphragm 52 changes in response to this, and regulating valve 55 and first reverse flow check valve 56 move with linkage to the changing of the position of shaft 522, and this executes opening and closing movements in reciprocally different directions and maintains as fixed the secondary pressure. The application force of regulator spring 513 can be changed by moving regulator screw 512, and this enables discretionary setting of the secondary pressure.

Moreover, when pressure regulation for changing the primary pressures is executed by regulating valve 55, they are the reciprocal opposite characteristics as those pressure regulation characteristics executed by first reverse flow check valve 56, and for a drop in primary pressure, secondary pressure is raised by regulation of regulating valve 55 and lowered by regulation of first reverse flow check valve 56. Therefore, because the pressure loss received by the reflection surface of regulating valve 55 due to operation of primary pressure on the leading end of shank 524 at shaft 522 and the pressure loss received by the reflection surface of first reverse flow check valve 56 due to operation of secondary pressure on boss 523 both cause shaft 522 to retreat and operate in the same direction, the structure becomes such that it regularizes the fluctuations of the secondary pressure in relation to fluctuations of the primary pressure by combining both pressure regulating characteristics.

Rephrased, when secondary pressure fluid is discharged from regulation chamber 530 and the secondary pressure drops, diaphragm 52 regulates pressure for obtaining a fixed secondary pressure by shaft 522 shifting forward (a downward shift in drawing), regulating valve 55 operating in the direction for opening and first reverse flow check valve 56 operating in the direction for closing, the primary pressure fluid flowing into regulation chamber 530 after being reduced in pressure by regulating valve 55 and the secondary pressure rising, secondary pressure rising above the set value in conjunction with the drop in primary pressure being regulated by the degree of opening (pressure loss) of first reverse flow check valve 56, shaft 522 executing retreat shifting (an upward shift in drawing) by displacement of diaphragm 52, regulating valve 55 executing close shifting and reducing the guided amount of fluid.

The pressure regulation characteristics that accompany the fluctuations of primary pressure, specifically, when fluid has been delivered from main unit 11, can be considered the reception error of regulating valve 55 in relation to the gradual drop in primary pressure within pressurized container 12. The pressure loss of regulating valve 55 that occurs with performing of opening and closing movements of first reverse flow check valve 56 in the direction opposite to regulating valve 55 are in the same direction of the pressure loss of regulating valve 55 and are basically inverse properties. The regulating force characteristics derived from regulating valve 55 are properties with which the secondary pressure drops in relation to a rise in primary pressure. In this regard, the regulating characteristics derived from first reverse flow check valve 56 suppress the secondary pressure when primary pressure is low, and especially, when primary pressure is zero, it prevents reverse flow of fluid by the reverse check valve closing, and releases with a rise in primary pressure, and with characteristics with which the secondary pressure rises in relation to a rise in the primary pressure, these are inverse properties compared to the regulating characteristics derived from regulating valve 55 described above.

Both pressure regulating characteristics operate in the same direction in relation to shaft 522, and the regulating characteristics derived from a combination of two valves with inverse properties, regulating valve 55 and first reverse flow check valve 56, are able to obtain a fixed secondary pressure in relation to the fluctuations in the primary pressure. Rephrased, when the primary pressure drops with fluctuation in conjunction with supply of fluid from pressurized container 12, by the pressure loss operating on regulating valve 55, the pressure loss operating on first reverse flow check valve 56 becomes the characteristics for reducing the secondary pressure, and the composite characteristics for both sides is leveled and the fixed secondary pressure maintained, and this is assured with a simple structure.

In addition, with the separation condition and unused condition, there is design for prevention of fluid leakage by the operation of first reverse flow check valve 56 and second reverse flow check valve 57 as a reverse check valve.

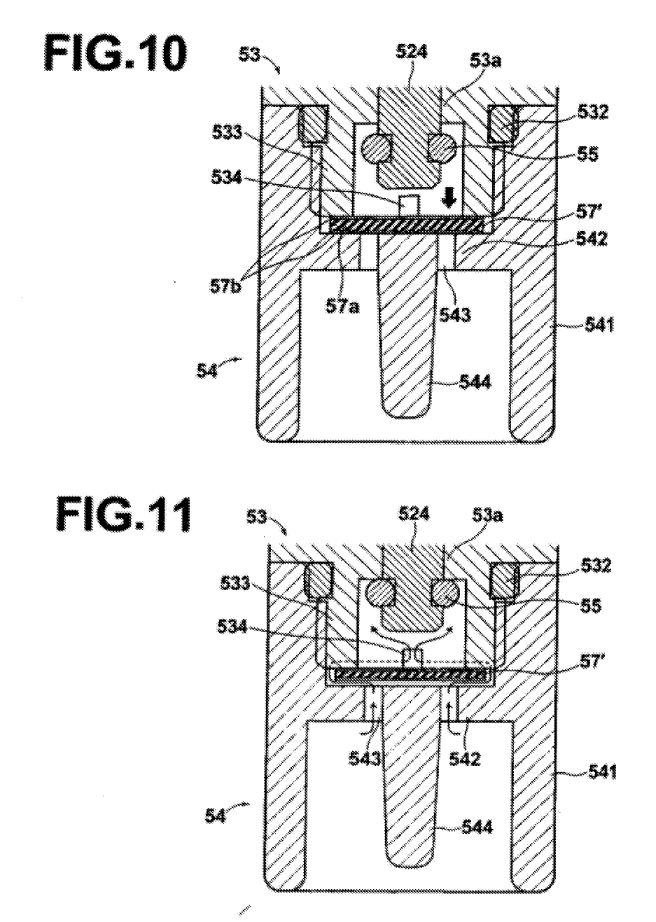

FIGS. 10 and 11 are drawings showing second reverse flow check valve 57′ of another embodiment, and while the form of second reverse flow check valve 57 of the previously described embodiment was an example formed of a single elastic plate that was specifically a rubber plate, second reverse flow check valve 57′ of this example is formed of an elastic plate such as Poron with an interior of a foam body 57a and possessing an impermeable coat 57b on the upper and lower surfaces. This would have light weight by formation with foam body 57a and it would not have gas passage properties for passage in the upper and downward direction due to coat 57b, and when pressure on the guidance port side is lower than the secondary pressure or higher than the secondary pressure, it quickly blocks passage hole 543 of barrier wall 542 due to pressure being applied from the upward side in the drawing, and this provides stable reverse flow check operation.

When using this second reverse flow check valve 57′, there is potential for compression deformity, and it will be restrained in a compressed condition between the leading edge of joining cylinder 533 of unit case 53 and the upper surface of barrier wall 542 of guide member 54, as shown in FIG. 10.

FIG. 11 shows the condition in which pressurized fluid is being introduced, and by the compression deformity of second reverse flow check valve 57′ due to pressure of the pressurized fluid operating from passage hole 543, there is opening of passage hole 543 by separation from the upper surface of barrier wall 542, and the pressurized fluid thus introduced flows into the inner peripheral side by passing through leading edge notch 534 of joining cylinder 533, and it thereby flows to regulation chamber 530 by passing regulating valve 55.

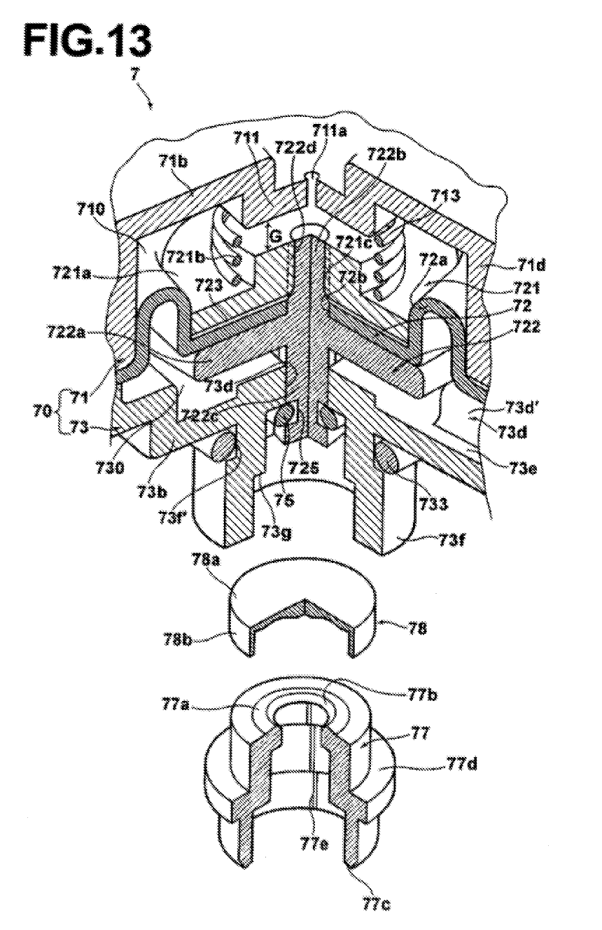

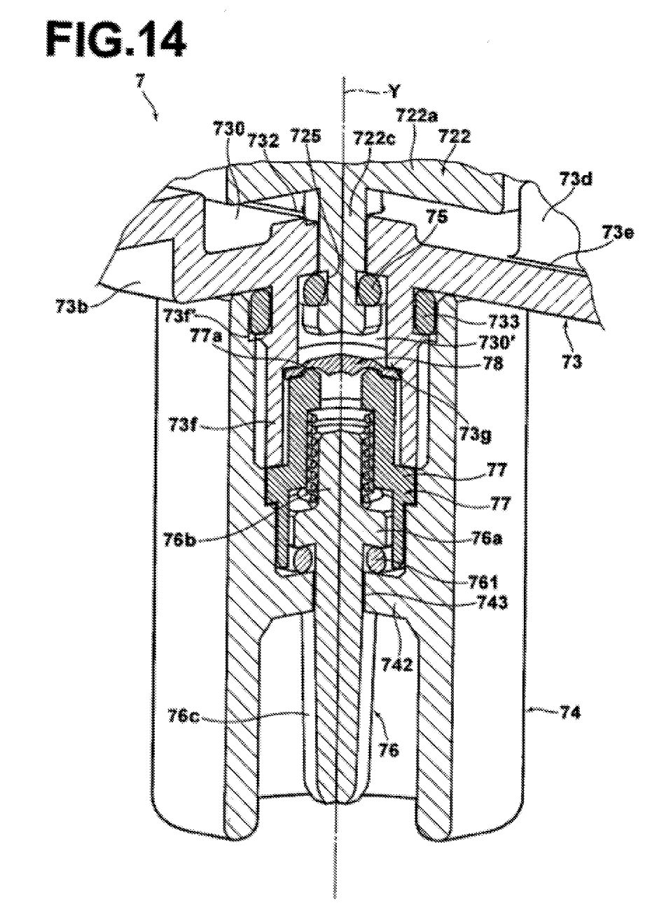

The next section describes another implementation form of the pressure regulating mechanism of this invention by referencing FIGS. 12˜14. Moreover, connector 2 and pressurized container 12 use forms identical to those used in the previously described embodiments, so those descriptions are omitted with this embodiment. FIG. 12 is a partial cross section perspective drawing showing a cutaway of an approximately 90 degree region along the circumference of the periphery of the Y axis passing through the center of pressure regulating mechanism 7 according to this embodiment and a partial expanded view, and FIG. 13 is a component expanded view cross section drawing showing an enlargement of the upper section of pressure regulating mechanism 7 of FIG. 12. FIG. 14 is a partial cross section expanded perspective drawing showing the assembled lower section of pressure regulating mechanism 7 of FIG. 12 with a cutaway of an approximately 90 degree region along the circumference of the periphery of the Y axis and a partial expanded view.

As shown in FIG. 12, pressure regulating mechanism 7 possesses housing 70 comprising unit case 73, cover case 71, and cylindrically shaped guidance member 74 installed to unit case 73. Unit case 73 and cover case 71 possess respectively expanded protrusion 73b and expanded protrusion 71b, and they also possess on the outer circumference identically shaped flange 73a and flange 71a. At expanded protrusion 73b, passage hole 73d is formed in a position corresponding to the Y axis (FIGS. 13 and 14). Unit case 73 and cover case 71 are reciprocally mated by flange 73a and flange 71a, and flange 73a and flange 71a are joined by such as screws (not shown).

At mating surface 70a for unit case 73, cover case 71 (FIG. 12), cavity 73c is formed to span the entire inner side of flange 73a. Diaphragm 72 is disposed at this cavity 73c, and by mating of flange 73a and flange 71a diaphragm 72 is fixed by pressing between flange 73a and flange 71a. Because diaphragm 72 is maintained in a fixed position through formation of cavity 73c, at time of mating and press fixing, diaphragm 72 is assembled with turning upward, and there is enabled the reduction of potential for generation of poor conditions such as fluid leakage.

Diaphragm 72 is of an approximately flat shaped material possessing elasticity and formed of rubber, for example, and it possesses drooping curvature 72a formed in a circular shape with the Y axis as its center (FIG. 13). In addition, at diaphragm 72, circular shaped opening 72b is formed in a location corresponding to axis Y (FIG. 13). Supporter 721 is disposed on the upper surface of the inner side from drooping curvature 72a of diaphragm 72.

On the other side, shaft 722 is disposed opposite supporter 721 to interpose diaphragm 72. Furthermore, at this point the upward and downward indications refer to the upward and downward directions of FIGS. 12˜14.

Supporter 721 possesses flat section 721a contacting the upper surface of diaphragm 72 (FIG. 13), and protrusion section 721b protruding upward from flat section 721a. It is preferred that supporter 721 be of a lightweight material such as polyoxymethylene (POM), but a metal is also acceptable. The upper surface of protrusion section 721b is formed to be flat. In addition, at protrusion section 721b, female screw threads 721c are formed along the Y axis (FIG. 13).

Shaft 722 possesses flat section 722a for positioning the lower surface of diaphragm 72 (FIG. 13) and shafts 722b and 722c extending respectively in the upper and lower directions from flat section 722a (FIG. 13). Shaft 722b protrudes upward while passing through opening 72b of diaphragm 72, and shaft 722c extends downward while passing through passage hole 73d (FIGS. 13 and 14). Male screw threads 722d are formed at shaft 722b, and these mate with previously described female screw threads 721c of supporter 721, resulting in a structure that tightly fastens diaphragm 72 from both sides. In this way, diaphragm 72 is integrally structured by interposition between supporter 721 and shaft 722. Moreover, it is preferred that there be interposed film 723 of a material with a small friction coefficient such as polyethylene terephthalate (PET) between supporter 721 and diaphragm 72. At mating of supporter 721 to shaft 722b, this will allow reduction of concern regarding deformity diaphragm 72 due to such as friction force generated at time of fastening. Furthermore, in this embodiment, film 723 is interposed as described above, but it is also acceptable to interpose such a film in like manner on pressure regulating mechanism 5 of the previously recorded embodiment.

At the inner side of expanded protrusion 71b of cover case 71, protruding section 711 is formed in a position opposite protrusion section 721b. The leading edge of lower surface of protruding section 711, specifically the lower surface, is formed with a flat surface identical to that of the upper surface of supporter 721. Small hole 711a is formed in the center of protruding section 711 and passes to the exterior (FIG. 13). Because the exterior is normally at atmospheric pressure, the space within expanded protrusion 71b is maintained at atmospheric pressure, and this space is atmospheric chamber 710.

Pressure regulating spring 713 is disposed at the periphery of protrusion section 721b of supporter 721 and protruding section 711 of cover case 71. This pressure regulating spring 713 ordinarily applies a prescribed pressing pressure downward onto diaphragm 72 through supporter 721. Between the lower surface of protruding section 711 and the upper surface of protrusion section 721b, gap G is maintained during normal usage conditions for pressure regulating mechanism 7 (FIG. 13). In this way, when the supply pressure of the fluid becomes excessively high, hereafter described shaft 722c of shaft 722 is pressed and lifted upward, and by contact of the upper surface of protrusion section 721b of supporter 721 against the lower surface of protruding section 711, there is enabled prevention of excess deformity of diaphragm 72.

In cover case 71, extension 71c is formed by expansion in the horizontal direction from expanded protrusion 71b (FIG. 12). Discharge port 714 is formed at extension 71c, and pipe 715 is formed to extend to the exterior from extension 71c. In addition, pillar-shaped space 710a is formed in cover case 71 and passes to discharge port 714 next to barrier wall 71d (FIG. 12). On the opposite side, approximately pillar-shaped space 730a is formed in the section of unit case 73 opposing space 710a and next to barrier wall 73d. In FIGS. 12 and 13, end surface 73d′ of barrier wall 73d is visible (FIG. 13), and the other end surface of barrier wall 73d is positioned facing this end surface 73d′, and channel 73e is structured between these companion end surfaces by their cooperative operation (FIGS. 13 and 14). At unit case 73 facing space 730a, approximately annular-shaped step section 730b is formed facing upward. In addition, circular opening 72c is formed within diaphragm 72 in opposition to space 710a and space 730a (FIG. 12). At space 710a and space 730a, cylinder section 731 possessing flange 731a is disposed and passes through opening 72c of diaphragm 72. At such disposition, flange 731a of cylinder section 731 seats into step section 730b. Cylinder section 731 is dimensionally positioned in a lengthwise direction such that a gap is formed its lower surface and the inner surface of expanded protrusion 73b, and this becomes a route for leading fluid passing through channel 73e to discharge port 714. Specifically, the route becomes a port for discharging the pressurized fluid stored in hereafter described regulation chamber 730. Cylinder section 731 is formed of polyoxymethylene (POM), for example. Moreover, in this embodiment there were formed extension 71c, discharge port 714 and pipe 715 in cover case 71, but there is no limitation to these with this invention, and it would be acceptable to establish an extension, discharge port and pipe in unit case 73, for example, as long as the structure enables supply of the fluid stored within the hereafter described regulation chamber to the exterior (a fuel cell, for example).

Between diaphragm 72 and expanded protrusion 71b of unit case 73, a space, specifically regulation chamber 730, is formed. At the leading edge of shaft 722c of shaft 722 that protrudes downward and passes through passage hole 73d of expanded protrusion 73b, peripheral channel 725 is formed (FIG. 13), and regulating valve 75 is installed in this peripheral channel 725. Regulating valve 75 is driven upwards and downwards by diaphragm 72, and it is structured to regulate the fluid pressure within regulation chamber 730 by blocking or opening the flow of the fluid passing between shaft 722c and passage hole 73d. Furthermore, because diaphragm 72 possesses elasticity as described above, at cant of shaft 722, specifically shaft 722c on which regulating valve 75 has been installed, due to such as vibration of elastic diaphragm 72, there is a danger that the seat of lower surface of expanded protrusion 73b will be damaged and pressure control will become poor, and for this reason the periphery of flat section 722a of shaft 722 is supported for cant by barrier wall 73d of unit case 73 and the inner surface of expanded protrusion 73b. By performing cant support at a position of relative proximity to diaphragm 72 in this way, it is possible to further reduce cant of shaft 722c.

In addition, as shown in FIG. 14, at the upper surface of unit case 73, specifically the surface facing regulation chamber 730, passage channel 732 for passing fluid that has transited the previously described gap is disposed with orientation from inward to outward so as to extend from described gap and at a position facing and interposing the described discharge port and shaft 722c. By this structure, when the pressure of the fluid supplied from previously described pressurized container 12 is low, it is possible to prevent the impeding of fluid flow by contact of the lower surface of flat section 722a of shaft 722 with the upper surface of unit case 73 through the shifting of shaft 722 downward due to opening movement on described regulating valve 75.

In addition, because the flow of fluid spans a wide area of regulation chamber 730 due to the disposition of passage channel 732 in position facing and interposing the described discharge port and shaft 722c, the gas within regulation chamber 730 has difficulty remaining, and it is possible to improve the operational stability of pressure regulating mechanism 7 by reducing the cause of abnormal vibration (so-called chattering; hereafter referred to as chattering) of diaphragm 72. Moreover, with this embodiment, passage channel 732 is formed as described above, but it is acceptable to form the passage channel in unit case 53 of pressure regulating mechanism 5 of the previously described embodiment.

Additionally, regulation chamber 730 of this embodiment is approximately formed only by the shifting space of diaphragm 72 and shaft 722 and the fluid route. Normally, with pressure control of compressible fluids such as a gas, when there is generation of input having a momentary pressure difference by such as opening or closing of a valve, the fluid can easily vibrate, and in order to restrain chattering of the diaphragm due to this vibration, it has been necessary to sufficiently enlarge the regulation chamber as a buffer for absorbing the pressure difference, but with a non-compressible fluid such as a liquid, it is difficult for the fluid to generate vibration, and so if it is possible to reduce the volume of regulation chamber 730, that will allow formation of regulation chamber 730 as described above.

Furthermore, annular wall 73f is disposed protruding downward from expanded protrusion 73b of unit case 73 so as to encompass the leading section of shaft 722c. Channel 73f is formed in annular shape at the base end periphery of annular wall 73f (FIG. 13), and O-ring 733 is installed in channel 73f. Screw threads not shown in the drawing can be formed at the periphery of annular wall 73f, for example, to allow structuring so as to mate with guidance member 74.

Guidance member 74 is a member for connecting supply connection fixture 3 of pressurized container 12 (reference FIG. 1), and it possesses barrier wall 742 at an intermediate point of its lengthwise direction. At barrier wall 742, opening 743 is formed to receive linking protrusion 76c. Additionally, the inner surface that encompasses the received linking protrusion 76c, specifically the inner surface lower than barrier wall 742, possesses a taper that becomes larger in aperture diameter at it progresses in the downward direction. (This is a very slight taper and is therefore not shown in the drawing.) By structuring in this way, it is possible to smoothly insert described valve mechanism 6 when connecting supply connection fixture 3, and this improves operability. This taper is established so that a seal will be obtained by seal member 33 before valve stem 61 of valve mechanism 6 is opened when connecting described supply connection fixture 3. Furthermore, the angle formed between the described inner surface and barrier wall 742 is C surface 744. With this structure, it is possible to reduce the the dead space within guidance member 74, and it is possible to reduce fluid leakage at time of connector or removal of supply connection fixture 3. Additionally, in this embodiment, there were formed the taper and C surface described above, but it is also acceptable to in the same way form the taper and C surface on guidance member 54 of pressure regulating mechanism 5 of the previously described embodiment.

Further, in top down order, filter 78, joint 77, compression coil spring 79 (hereafter referred to as spring 79) and plug 76 are disposed between expanded protrusion 73b barrier wall 742.

Joint 77 is formed of polyoxymethylene (POM), for example, and is of approximately cylindrical shape possessing upper wall 77a. Hole 77b is formed in the center of upper wall 77a of joint 77, and annular-shaped flange 77d extends outward from a location between upper wall 77a and lower end 77c.

Filter 78 is of a shape by which annular wall 78b suspends from the periphery of circular plate section 78a, and it crowns upper wall 77a of joint 77. By using these shapes, it is possible to easily position filter 78 at time of placing filter 78 on guidance member 74, and it allows improvement of operability. In addition, by obtaining a seal with annular wall 78b at the outer periphery of joint 77, there is no leaking from hole 77b of fluid that has passed the previously described fluid route of joint 77, and this allows reliable passage through filter 78. Moreover, because there is no contact with valve mechanism 6 when connecting or removing supply connection fixture 3 due to the disposition of filter 78 above barrier wall 742, it is possible to reduce the possibility of filter 78 being dislodged. Furthermore, the fluid passage surface area for passing fluid through filter 78 can vary according to the the size of hole 77b, and making this fluid passage surface area larger will allow the flow speed of the fluid to become greater. Accordingly, it is possible to quickly supply fluid at times such as the initial condition in which there is no fuel (fluid) within the fuel cell.

Moreover, in this embodiment, filter 78 was of the above described shape, but it is not limited to such with this invention, and it is acceptable for it to be of a plate shape, for example. Additionally, the material of filter 78 can be identical to that of filter 58 of the previously described embodiment, so a description is omitted here.

Regarding joint 77 in the assembled condition, flange 77d contacts the lower end of annular wall 73f of unit case 73, and filter 78 is maintained between step 73g facing downward from annular wall 73f and upper wall 77a of joint 77. The upper section of filter 78 forms intermediate regulating chamber 730′ into which protrudes the leading end of shaft 722c of shaft 722 (FIG. 14). At the inner surface of joint 77, channels 77e proceeding in the vertical direction (FIG. 13) are formed in multiple number and reciprocally separated along the inner periphery of joint 77. These channels 77e become fluid routes for passage of supplied pressurized fluid.

Previously mentioned plug 76 is of a pin shape formed of stainless steel or polyoxymethylene (POM), and it possesses circular-shaped flange 76a in proximity to the upper end. Upper shaft 76b protrudes upward from flange 76a, and it possesses a diameter that allows insertion within the inner surface of spring 79. Lower shaft 76c protrudes downward from flange 76a, and it possesses a diameter that allows insertion within the inner surface of spring 79, and its shape converges while progressing to the lower end of plug 76. Specifically, the taper is shaped to become narrower. O-ring 761 is crowned on lower shaft 76c in proximity to flange 76a. This lower shaft 76c becomes linking protrusion 76c for acting as the linking member that executes linking operation on previously described valve stem 61. Linking protrusion 76c provides regulating valve 75 and has a structure separated from shaft 722c that moves with linkage to diaphragm 72, and it does not receive force by the displacement of diaphragm 72 at connection movement. Rephrased, identically to the previously described embodiment, because diaphragm 72 and linking protrusion 76c are separated, there can be assurance of regulating function and prevention of the supply of fluid having a pressure higher than a set secondary pressure.

When guidance member 74 is installed against annular wall 73f, spring 79 and plug 76 are maintained between upper wall 77a of joint 77 and barrier wall 742 of guidance member 74. At this time, flange 76a of plug 76 is applied with downward force from spring 79, and O-ring 761 is pressed between flange 76a and barrier wall 742. When in a condition in which supply connection fixture 3 is not connected to guidance member 74, this O-ring 761 is in a condition of close contact against barrier wall 742 and flange 76 due to the application force of spring 79. In this way, the pressurized fluid within pressure regulating mechanism 7 is prevented from leaking to the exterior from between linking protrusion 76c of plug 76 and opening 743 of barrier wall 742. Because this mechanism is structured to be independent of regulating valve 725, there is no impact on such as the secondary pressure of the fluid or the secondary pressure setting.

Next, the following section references FIG. 15 to describe the condition in which there is utilization by connection of supply connection fixture 3 to pressure regulating mechanism 7 as described above. FIG. 15 shows a cross section of pressure regulating mechanism 7 to which supply connection fixture 3 has been connected. Furthermore, FIG. 15 shows a cross section of the main components. As shown in the drawing, when supply connection fixture 3 is connected to pressure regulating mechanism 7, plug 76 is pressed upward by stem 61. At this time, because plug 76 is provided, specifically linking protrusion 76c and regulating valve 75, and is formed separately from shaft 722c that moves with linkage to diaphragm 72, no force is applied to diaphragm 72 by the described pressing force, and there is no impact on pressure regulating function.

Further, opening 743 of guidance member 74 that was sealed by O-ring 761 undergoes opening action, and pressurized fluid passes through in the order of opening 743, channel 77e on the inner side of joint 77, and filter 78. At the connection initiation condition for supply connection fixture 3, because the pressure of the fluid is low within regulation chamber 730, diaphragm 72 is in a condition with force applied downward from pressure regulating spring 713. Accordingly, because regulating valve 75 that seals passage hole 73d of unit case 73 is shifting in the separation direction downward from passage hole 73d, the condition is one with the block sealing of passage hole 73d released. Therefore, there is supply from discharge port 714 to the fuel cell of the fluid that has passed the described route for the structured fluid route, filter 78, intermediate regulating chamber 730′, between passage hole 73d and shaft 722c, regulation chamber 730 and cylinder section 731.

In the normal operating condition, diaphragm 72 is set so that a prescribed pressure will result within regulation chamber 730 according to pressure regulating spring 713 control in opposition to the pressure of the supplied fluid, which could be, for example, 900 KPa˜1 MPa. Specifically, when the pressure of the fluid supplied from supply connection fixture 3 is higher than the fluid pressure expected to be supplied, there is resistance by application of force from pressure regulating spring 713 and the fluid within regulation chamber 730 presses upward on diaphragm 72. The result is that shaft 722c of shaft 722 shifts upward, regulating valve 75 block seals passage hole 73d of unit case 73, and fluid at pressure above this level is prevented from flowing into regulation chamber 730. Not only is the pressure added to diaphragm 72 from the pressurized fluid side a pressure strictly maintained within regulation chamber 730, but there is also addition of force to regulating valve 75 within intermediate regulating chamber 730′. Specifically, because the primary pressure within intermediate regulating chamber 730′ for reflection surface X of the regulating valve is added to regulating valve 75, there may occure closure of regulating valve 75 even by the pressure of the previously described pressurized fluid pressure, or there may occur a deformation by an intrusion of regulating valve 75 into the valve seat. When the pressure within regulation chamber 730 has become low, by the application force of pressure regulating spring 713, shaft 722c of shaft 72 descends and opens passage hole 73d, and pressurized fluid can once again flow into regulation chamber 730.

In this way, diaphragm 72 ceaselessly shifts upwards or downwards corresponding to the fluctuations of the pressure of the fluid. However, because the amount of upward or downward shifting is extremely small, approximately 0.3 mm, for example, the previously described gap G, specifically the dimension between the upper surface of protrusion section 721b of support 721 and the lower surface of protruding section 711 of cover case 71 is maintained as approximately fixed. Moreover, in the condition in which pressurized fluid is flowing, regulating valve 75 is shown as contacting unit case 73, but in actuality, the gap between regulating valve 75 and unit case 73 is extremely small and passage of pressurized fluid becomes possible.

1. A pressure regulator that is a pressure regulator providing a main unit with a built-in pressure regulating mechanism and a connector disposed on said main unit to which is connected a supply connection fixture that supplies a pressurized fluid,
and is characterized by providing within said connector a linking member for opening a valve mechanism of said supply connection fixture corresponding to the connection movement of said supply connection fixture,
and by providing a regulating valve that moves corresponding to the displacement of a diaphragm and pressure regulates an introduced pressurized fluid to a prescribed secondary pressure,
and is formed with separation of said linking member and said regulating valve.

2. A pressure regulator according to claim 1 in which said valve mechanism is one possessing a valve stem for the axis of said valve mechanism in the approximate center,
and is characterized by said linking member being structured with a linking protrusion that extends in the connection movement direction, and that the leading edge of said linking protrusion contacts against said valve stem and causes an opening operation at time of connection of said connector and said supply connection fixture.

3. A pressure regulator according to claim 2 in which said pressure regulating mechanism is one possessing a guidance member of approximately cylindrical shape,
and is characterized by said guidance member possessing a barrier wall that protrudes inward at a prescribed position in the connection movement direction,
and by said barrier wall possessing said linking protrusion in the approximate center, and by said linking protrusion possessing passage holes on two sides for allowing passage through said barrier wall.

4. A pressure regulator according to claim 2 in which said pressure regulating mechanism is one possessing a guidance member of approximately cylindrical shape,
and is characterized by said guidance member possessing a barrier wall protruding inward at a prescribed location in the connection movement direction,
by said barrier wall possessing in the approximate center an opening to allow passage of said linking protrusion,
and by providing, at the opposite side of the side at which said supply connection fixture is connected, a joint of approximately cylindrical shape for housing a plug possessing said linking protrusion.

5. A pressure regulator according to any of claims 1˜3 characterized by further providing, at the inner side and outer side of said regulating valve of said pressure regulating mechanism, two reverse flow check valves for preventing reverse flow of the fluid.

6. A pressure regulator according to either of claims 3 or 4 characterized by said guidance member possessing a taper on the inner surface enclosing said linking protrusion that becomes larger in aperture diameter at it progresses toward the side of the supply connection fixture.

7. A pressure regulator according to claim 3 characterized by fastening, at the barrier wall surface of the side at which said supply connection fixture is connected, a filter for debris removal of cylindrical shape that allows through passage of said linking protrusion and fills said passage holes.

8. A pressure regulator according to claim 3 characterized by said joint providing, at the end of the opposite side of the side to which said supply connection fixture is connected, a filter for debris removal that crowns said end.

9. A pressure regulator that is a pressure regulator providing a main unit with a built-in pressure regulating mechanism and a connector disposed on said main unit to which is connected a supply connection fixture that supplies a pressurized fluid,
and is characterized by said pressure regulating mechanism providing a regulating valve that moves corresponding to the displacement of a diaphragm and pressure regulates an introduced pressurized fluid to a prescribed secondary pressure, and providing, at the inner side and outer side of said regulating valve, two reverse flow check valves for preventing reverse flow of the fluid.

10. A pressure regulator according to claim 9 characterized by said two reverse flow check valves being structured by disposing at the inner side of said regulating valve a first reverse flow check valve for low pressure operation that performs closing operation in conjunction with displacement of said diaphragm, and by disposing at the outer side of said regulating valve a second reverse flow check valve that performs closing operation by receiving pressure emitted from the interior.

11. A pressure regulator according to claim 10 characterized by said second reverse flow check valve being structured of an elastic plate that blocks the opening of the passage route.

12. A pressure regulator according to claim 11 characterized by said elastic plate being of a foam body in the interior and possessing on the exterior an impermeable coating.

13. A pressure regulator according to any of claims 1˜12 characterized by said diaphragm comprising a first surface on the side of said connector and a second surface on the opposite side, and being such that it is held between a unit case that forms in conjunction with said first surface a pressure regulating chamber for storing said pressurized fluid and a cover case that forms in conjunction with said second surface an atmospheric chamber that passes through to the atmosphere,
and said unit case disposing on the diaphragm side surface a cavity for housing said diaphragm.

14. A pressure regulator according to claim 13 characterized by said unit case establishing at least one passage channel for the passage of said stored pressurized fluid on the surface facing said regulating chamber.

15. A pressure regulator according to claim 14 characterized by said regulating chamber being such that it possesses a discharge port for discharging pressurized fluid that has been regulated to said prescribed secondary pressure, and that said passage channel interpose the central axis of the direction of said connection operation and be disposed in a position opposite said discharge port.
